(19) United States
(12) Patent Application Publication
(10) Pub. No.: US 2016/0038838 A1
(43) Pub. Date: Feb. 11, 2016

(54) CONSUMER ENGAGEMENT GAMING PLATFORM

(71) Applicant: Adformics, Inc., San Diego, CA (US)

(72) Inventor: Samuel Cho, San Diego, CA (US)

(21) Appl. No.: 14/920,845

(22) Filed: Oct. 22, 2015

Related U.S. Application Data
(63) Continuation-in-part of application No. 14/105,160, filed on Dec. 12, 2013.

(51) Int. Cl. A63F 13/61; A63F 13/52; A63F 13/80

(52) U.S. Cl. CPC A63F 13/61; A63F 13/80; A63F 13/52

(57) ABSTRACT

An automated method that provides access to gated content is described. The method is performed by a device comprising a processor. The method includes: receiving content associated with an advertising item; retrieving game content; providing a gaming environment including the advertising item; determining, via the gaming environment, whether a set of engagement criteria has been satisfied; and providing a first set of options when determining that the set of engagement criteria has been satisfied, where the first set of options includes access to a gated content item. The automated method further includes providing a second set of options when determining that the set of engagement criteria has not been satisfied, where the second set of options excludes access to the gated content item.

### CROSS-REFERENCE TO RELATED APPLICATIONS

This application is a continuation-in-part of U.S. patent application Ser. No. 14/105,160, filed on Dec. 12, 2013.

### BACKGROUND OF THE INVENTION

The present disclosure is related to engagement of consumers through content provided using various sets of networks (e.g., the Internet or “world wide web”). Various consumers may be presented with a multitude of online content items including gated, or premium, content, advertisements or “ads” (e.g., banner ads, pop-up ads, etc.), etc. Such content items may be provided by various appropriate sources (e.g., content providers, ad servers, etc.).

Present solutions may allow consumers to ignore various advertisements (e.g., video and/or audio playback may be muted or moved to the background, users may quickly close or block pop-up windows or tabs, display ads may not draw attention, etc.).

Therefor there exists a need to present online advertising to consumers such that the consumers are engaged with the advertising content. In addition, there exists a need for a user-friendly, efficient way to provide access to gated content while engaging the consumer in the process. Furthermore, such a solution should utilize standard protocols and systems to implement various consumer engagement features that are scalable across multiple platforms and/or devices.

### BRIEF SUMMARY OF THE INVENTION

Some embodiments may provide a way for content providers to generate and deploy engagement elements. Such engagement elements may require user interaction in order to receive access to one or more content items such as premium content provided by a publisher or to engage with web-based advertising. Engagement elements may include, for example, games (e.g., shooting games, word-based games, puzzle games, etc.), multimedia (e.g., video content, photographic content, etc.), and/or other appropriate engagement features.

Content may be provided at various appropriate devices (e.g., smartphones, tablets, laptops, etc.). The content may be provided via a web browser, dedicated application, in-app interface, and/or other appropriate ways. Some embodiments may present content in cross-screen configurations where multiple devices are used to present a set of content items.

A content provider may be able to generate engagement elements with various appropriate characteristics (e.g., size, type of content, etc.). Such engagement elements may be associated with various existing advertising networks, ad formats, etc. The engagement elements may be able to automatically interact with external resources such as ad servers and/or content servers (e.g., via one or more application programming interfaces (APIs) using various commands, calls, messages, etc.).

The engagement elements may be deployed as snippets of code that are able to be embedded in various web pages (and/or other appropriate media). Such engagement elements may be specified as a hypertext link, API call, and/or other appropriate way such that the engagement element is deployed based at least partly on live server-client interaction provided by some embodiments.

When a user loads a web page (or other appropriate element) including one or more engagement elements, the user may be required to interact with an element in various appropriate ways before access is granted to premium content. Alternatively or conjunctively, such engagement elements may allow a user to interact with display ads presented in a web page.

Some engagement elements may provide a gaming environment that includes embedded engagement elements. Such elements may be embedded within various games provided via the gaming environment. The content may be manipulated and/or presented in various appropriate ways to suit the individual games. Some embodiments may manipulate and embed data such as keywords, slogans, etc. associated with the advertising content.

The preceding Summary is intended to serve as a brief introduction to various features of some exemplary embodiments of the disclosure. Other embodiments may be implemented in other specific forms without departing from the scope of the disclosure.

### BRIEF DESCRIPTION OF THE SEVERAL VIEWS OF THE DRAWINGS

The novel features of the disclosure are set forth in the appended claims. However, for purpose of explanation, several embodiments of the disclosure are set forth in the following drawings.

FIG. 1 illustrates a schematic block diagram of an exemplary hardware system provided by some embodiments;

FIG. 2 illustrates a schematic block diagram of an exemplary software system provided by some embodiments;

FIG. 3 illustrates a flow chart of an exemplary process used by some embodiments to generate an ad tag;

FIG. 4 illustrates a flow chart of an exemplary process used by some embodiments to generate engagement code;

FIG. 5 illustrates a flow chart of an exemplary process used by some embodiments to link engagement code to a set of advertisements;

FIG. 6 illustrates a flow chart of an exemplary process used by some embodiments to provide a first mode of user engagement;

FIG. 7 illustrates a flow chart of an exemplary process used by some embodiments to provide a second mode of user engagement;

FIG. 8 illustrates a message flow diagram of an exemplary communication scheme used by some embodiments to provide various modes of user engagement;

FIGS. 9-11 illustrate various exemplary user interfaces associated with the first mode of user engagement;

FIGS. 12-14 illustrate various exemplary user interfaces associated with the second mode of user engagement;

FIG. 15 illustrates a flow chart of an exemplary process used by some embodiments to integrate content into a gaming environment;

FIGS. 16-23 illustrate various exemplary user interfaces associated with the gaming environment; and

FIG. 24 conceptually illustrates a schematic block diagram of a computer system with which some embodiments of the disclosure may be implemented.

### DETAILED DESCRIPTION OF THE INVENTION

The following detailed description is of the best currently contemplated modes of carrying out exemplary embodiments of the disclosure. The description is not to be taken in a limiting sense, but is made merely for the purpose of illustrating the general principles of the disclosure, as the scope of the disclosure is best defined by the appended claims.

Various inventive features are described below that can each be used independently of one another or in combination with other features.

Broadly, embodiments of the present disclosure generally provide a way for content providers and/or advertisers to engage consumers who access web-based content.

A first exemplary embodiment provides an automated method that provides access to gated content. The method is performed by a device including a processor. The method includes: receiving content associated with an advertising item; retrieving game content; providing a gaming environment including the advertising item; determining, via the gaming environment, whether a set of engagement criteria has been satisfied; and providing a first set of options when determining that the set of engagement criteria has been satisfied, where the first set of options includes access to a gated content item.

A second exemplary embodiment provides a user device that displays content. The user device includes: a processor for executing a set of instructions; and a non-transitory medium that stores the set of instructions. The set of instructions includes: receiving, from a server, content associated with an advertising item; retrieving, from the server, game content; providing, at the user device, a gaming environment including the advertising item; determining, via the gaming environment, whether a set of engagement criteria has been satisfied; and providing, at the user device, a first set of options when determining that the set of engagement criteria has been satisfied, where the first set of options includes access to a gated content item via the server.

A third exemplary embodiment provides a server that provides content to a user. The server includes: a processor for executing a set of instructions; and a non-transitory medium that stores the set of instructions. The set of instructions includes: sending, to a user device, content associated with an advertising item; retrieving game content; providing, to the user device, a gaming environment including the advertising item; determining, via the gaming environment, whether a set of engagement criteria has been satisfied; and sending, to the user device, a first set of options when determining that the set of engagement criteria has been satisfied, where the first set of options includes access to a gated content item.

Several more detailed embodiments of the disclosure are described in the sections below. Section I provides an exemplary description of a system provided by some embodiments. Section II then describes various operating schemes used by some embodiments. Next, Section III describes various exemplary user interfaces that may be provided by some embodiments. Section IV then describes a gaming environment provided by some embodiments. Lastly, Section V describes a computer system which implements some of the embodiments of the disclosure.

### I. System

Sub-section I.A provides an exemplary description of a hardware architecture used by some embodiments. Sub-section I.B then describes an exemplary software architecture used by some embodiments. The systems described below are for example purposes only and different embodiments may be implemented with different combinations of hardware elements and/or different combinations of software elements, as appropriate. Such systems will typically include multiple hardware devices (e.g., a mobile device, a personal computer or “PC”, etc.), where each device may execute appropriate software (e.g., a web browser, server software, etc.).

A. Hardware Architecture

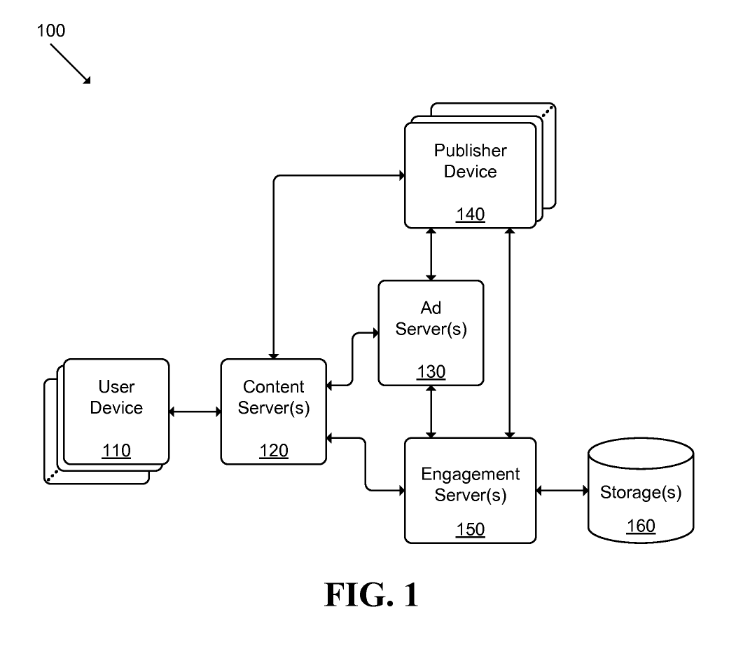

FIG. 1 illustrates a schematic block diagram of an exemplary hardware system 100 provided by some embodiments of the disclosure. Specifically, this figure shows the various elements and communication pathways that may be included in such a system. As shown, the system may include one or more user devices 110, one or more content servers 120, one or more ad servers 130, one or more publisher devices 140, and one or more engagement servers 150 with associated storage(s) 160.

Each user device 110 may be any device capable of accessing an online server through one or more networks (e.g., local area wireless networks, wired networks, distributed networks, cellular networks, etc.). Such devices may include devices such as, for example, PCs, smartphones, tablet devices, laptops, etc.

Each content server 120 may be a device or set of devices capable of storing content (e.g., text, video, multimedia, etc.) and/or other data (e.g., user account information, links to external content, etc.) and providing the content to one or more users across one or more networks. Each content server may be accessed by a number of user devices 110 using, for instance, a web browser application (and/or other appropriate applications) and one or more network connections. The content servers 120 may be able to access various local or networked storages (not shown).

Each ad server 130 may be a device or set of devices capable of storing advertising content, user information, etc. and may be accessible across one or more network connections. In some embodiments, the ad server(s) may provide advertising content (e.g., text, multimedia, etc.) to each of the content servers 120. The ad servers 130 may be able to access various local or networked storages (not shown).

Throughout this disclosure, the term “server” may be used to refer to the content server 120, the ad server 130, a gaming server, authentication servers, and/or other network-accessible devices. In some cases, a single server device may communicate with a user device 110 and also multiple other servers (and/or types of servers).

Each publisher device 140 may be any device capable of accessing an online server through one or more networks (e.g., local area wireless networks, wired networks, distributed networks, cellular networks, etc.). Such devices may include devices such as, for example, PCs, smartphones, tablet devices, etc. In some embodiments, publisher devices 140 and user devices 110 may refer to similar devices that are associated with different types of system users. Publisher devices 140 may be used by content providers, advertising services, and/or other similar types of users. Thus, each publisher device may be able to access the content servers 120, ad servers 130, and engagement servers 150, while user devices 110 may be limited to accessing the content servers 120 (which may still allow these users to indirectly access other system elements via the content servers).

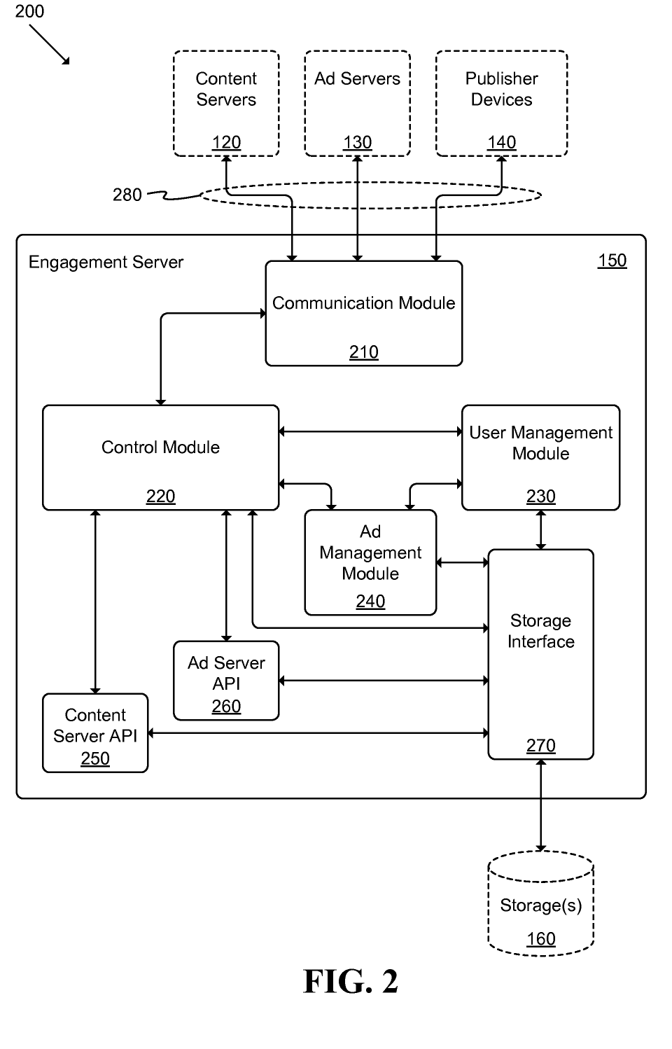

The set of engagement servers 150 may be implemented using one or more devices capable of processing data and/or instructions. The engagement servers may be able to access one or more local or networked storages 160. The functional characteristics of the engagement servers 150 will be described in more detail in reference to FIG. 2 below.

During a typical operation scenario, system 100 may allow a publisher (via a publisher device 140) to generate content that is able to be reached via the content server 120. The publisher (and/or other appropriate entity) may then generate various ads and/or engagement elements using the ad server 130 and/or engagement server 150. Alternatively, the ads may be retrieved automatically from an ad exchange and/or other appropriate service. Likewise, the engagement elements may be retrieved and/or generated automatically by the engagement server 150. The engagement elements may then be embedded into the content that is able to be accessed via user devices 110. Such elements may use standard units (e.g., units established by the Interactive Advertising Bureau or “IAB”) or may be customized to meet various criteria established by the publishers, users, and/or other appropriate parties.

When a user (via user device 110) accesses content provided by the content servers 120, various ads may be automatically retrieved from the ad servers 130. Some such ads may include references to engagement elements that may be automatically retrieved from (and/or provided by) the engagement server 140. Such operation will be described in more detail in Section II below.

One of ordinary skill in the art will recognize that although system 100 has been described by reference to various specific examples and/or details, the system may be implemented in various different ways without departing from the scope of the disclosure. For instance, some embodiments may include additional elements (e.g., entities that may collect ads from various ad servers and provide the ads to one or more content servers) and/or some embodiments may include fewer elements (e.g., a merged set of content and ad servers). In addition, such a system may be implemented using various combinations of hardware elements and software elements, as appropriate.

B. Software Architecture

Some embodiments may be implemented at least partly using various software elements, systems, interfaces, etc. Different embodiments may utilize different combinations of code (e.g., HTML code, scripting code, tags, etc.) that may be executed by an appropriate application such as a web browser. Some embodiments may provide content via in-app interfaces.

Such code may include, for instance, various calls, messages, commands, etc. that may be selectively sent to one or more external resources (e.g., from a client user device to a host server device, from a server device to a third party server device, etc.). The code may also include, for instance, the ability to receive and/or respond to various calls, messages, commands, data, etc. that may be received from an external resource.

FIG. 2 illustrates a schematic block diagram of an exemplary software system 200 provided by some embodiments. Specifically, this figure shows the software elements executed by some embodiments of the engagement server 150. As shown, system 200 may include a communication module 210, a control module 220, a user management module 230, an ad management module 240, a content server API 250, an ad server API 260, and a storage interface 270.

The components executed by the engagement server 140 may be able to access (and/or be accessed by) software components executed by hardware elements such as the content servers 120, ad servers 130, publisher devices 140, and/or storages 160. Such access may utilize various interfaces, networks, and/or other communication pathways 280.

The communication module 210 may allow the engagement server 150 to communicate with various external resources (e.g., third-party servers, user devices, etc.) across various appropriate pathways (e.g., wired and/or wireless networks, the Internet, etc.). One of ordinary skill in the art will understand that the communication module 210 is an exemplary element and some embodiments may provide, for example, an API (and/or other appropriate interface) and/or storage that are able to be accessed directly via the Internet.

The control module 220 may oversee the operations of the engagement server elements and may facilitate communication and/or otherwise control interaction among those elements. In addition, the control module may perform and/or direct various tasks associated with the operation of the engagement server 150 (e.g., retrieving stored data, controlling access of external elements, etc.).

The user management module 230 may evaluate some or all access requests and may be used to authenticate such requests before allowing the requested access. For instance, a publisher-user may be required to set up a user account having, for example, a username and password. The username and password may subsequently be required to access data associated with the user account of the publisher-user. Such authenticated access may be required before a user is able to generate and/or modify engagement elements, ads, etc. In contrast, a consumer-user may not be required to set up a user account and may access data (e.g., published engagement elements, ads, etc.) provided by the engagement server 150 without being able to generate or modify such elements. However, some embodiments may identify particular consumer-users in other appropriate ways (e.g., using cookies, based on a referring source, etc.).

The ad management module 240 may manage advertising content. For example, the ad management module may allow a publisher-user to associate an engagement element with a set of ads provided by a third-party ad server. As another example, the ad management module may determine which ads and/or engagement elements may be provided to a consumer-user. The ad management module may be able to manage various multimedia content items whether related to advertising or not.

The content server API 250 may allow various third-party content servers 120 to access system data such as engagement elements, ads, etc. (and/or otherwise interact with the system). The ad server API 260 may allow various third-party ad servers 130 to access the system data (and/or otherwise interact with the system). In some embodiments, the APIs 250-260 may receive requests from external elements and automatically respond with the appropriate data (e.g., a content server may request an engagement element and the API may respond with the appropriate code). Alternatively, the API may send requests to external elements based on various appropriate criteria (e.g., data corresponding to various ads associated with an engagement element may be requested from an external ad server).

The storage interface 270 may allow various system elements to access and/or store data and/or instructions from and/or to storages 160. The storage interface 270 may allow access to local and/or networked physical storage elements, as appropriate.

During operation, a publisher-user may access the engagement server to generate some engagement element and/or associate the element with one or more ads. A consumer-user may subsequently view content provided by the publisher-user (e.g., a web page) and may be presented with the generated engagement element as part of the published content. The operation of system 200 will be described in more detail in Section II below.

One of ordinary skill in the art will recognize that although system 200 has been described with reference to various specific details, the system may be implemented in various different ways without departing from the scope of the disclosure. For instance, instead of the various components 210-270 described above, some embodiments may provide a single API that is accessible via the Internet and may allow external resources to access the engagement server 150 and/or the associated storages 160. As another example, different embodiments may include various additional modules or sub-elements. In addition, some embodiments may divide various modules or elements into a set of sub-elements and/or some embodiments may combine multiple modules or sub-elements into a single module or element.

### II. Operating Schemes

Sub-section II.A provides an exemplary description of the generation of engagement elements of some embodiments. Sub-section II.B then describes engagement of users with published engagement elements. Lastly, sub-section II.C describes a message flow used by some embodiments.

The exemplary processes, message flows, and operating schemes described below may be implemented using various physical devices or systems such as, for instance, system 100 or system 200 described above. Some of the operations may be implemented using only a sub-set of system elements, while other operations may be implemented using all system elements (and/or appropriate additional elements).

A. Generation of Engagement Elements

Engagement elements may include any facets of content that require user engagement with content. For instance, some embodiments may allow a user to view premium content only after completing a game or puzzle. As another example, some embodiments may “supercharge” existing static display ads by including some or all of the ad content within an engagement element such as a game. Such engagement elements may include code that is automatically generated and which may refer to external elements (e.g., ads provided by third-party servers).

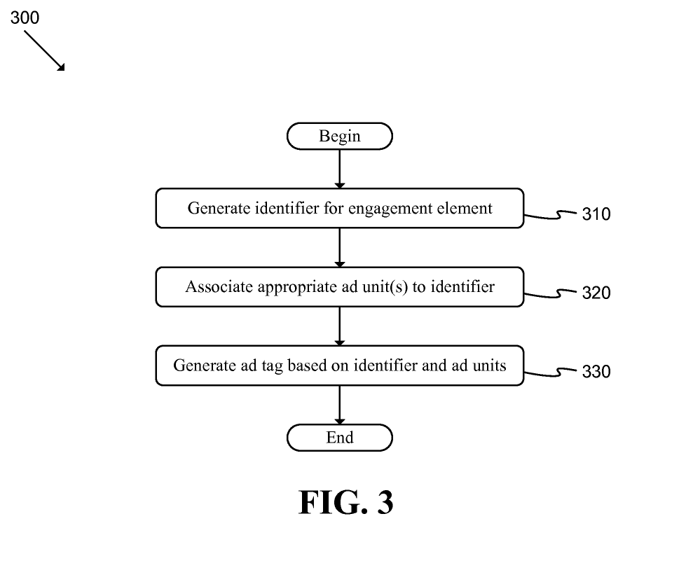

FIG. 3 illustrates a flow chart of an exemplary process 300 used by some embodiments to generate an ad tag. Such a process may begin, for instance, when a publisher-user accesses a system of some embodiments (e.g., by logging into an ad server).

As shown, the process may generate (at 310) an identifier for the engagement element to be created. Such an identifier may be generated in various appropriate ways (e.g., based on the publisher identity, based on time and/or date of creation, based on a random sequence of letters and/or numbers, etc.). Such an identifier may be formatted to comply with various appropriate standards (e.g., by including only alphanumeric characters, by including a specified number of characters, etc.).

Process 300 may then associate (at 320) an appropriate set of ad units to the identifier. Each ad unit may be specified by a vertical and horizontal number of pixels in some embodiments, and/or other appropriate ways. Such a set of ad units (or ad “sizes”) may be defined in various appropriate ways. For instance, a set of ad size selections may be received from the publisher-user. As another example, a set of ad sizes may be generated based on various parameters associated with the ad content (e.g., type of content, size or resolution of the content, etc.).

Next, the process may generate (at 330) an ad tag based at least partly on the identifier generated at 310 and/or the set of ad units associated with the identifier at 320. In some embodiments, the ad tag may include a set of parameters (e.g., ad unit selections, engagement element identifier, etc.). Alternatively or conjunctively, the ad tag may include a set of instructions or “code” (e.g., HTML code, script, etc.) and/or associated data that may be included by a publisher on a web page. The ad tag may be provided to the publisher, stored in a system-accessible storage, and/or otherwise made available for future use by a system of some embodiments. After generating (at 330) the ad tag, the process may end.

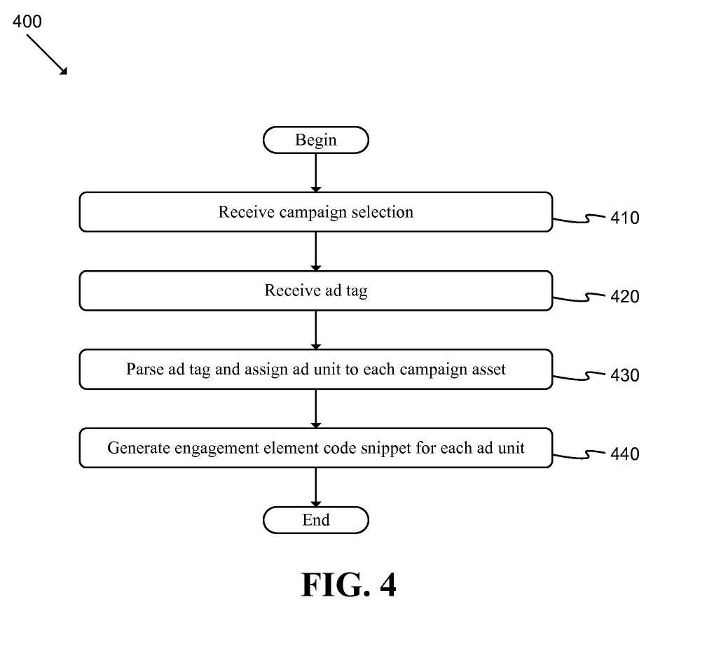

FIG. 4 illustrates a flow chart of an exemplary process 400 used by some embodiments to generate engagement code. Such a process may begin, for instance, when a publisher-user accesses a system of some embodiments (e.g., by logging into an engagement server). In some embodiments, process 300 may be performed before process 400 such that an ad tag is available. Alternatively, if no ad tag is available, process 400 may automatically generate such a tag.

Process 400 may then receive (at 410) a campaign selection. A campaign may define various sets of content, ad sources, specific advertisements, ad units, and/or other relevant parameters. Such a campaign may be created in various appropriate ways (e.g., based on received user selections, based on default parameters, etc.). The campaign selection may be received in various appropriate ways (e.g., a list of campaigns associated with a user may be presented to the user via a web interface, an active campaign may be automatically selected, etc.).

Next, the process may receive (at 420) an ad tag. Such an ad tag may have been generated using a process such as process 300 described above. In some embodiments, the ad tag may be associated with a specific set of ad servers (e.g., servers associated with a particular service for providing ads).

Process 400 may then parse (at 430) the ad tag and assign an ad unit to each asset associated with the campaign. Such ad units may be assigned from a list of potential ad units and may be assigned to each asset based on various relevant factors (e.g., type of asset, size or resolution of the asset, etc.). In some embodiments, the user may be able to preview the ad units and approve or modify each ad unit, as desired.

The process may then generate (at 440) an engagement element code snippet for each ad unit and then may end. Such code snippets may include data and/or instructions that are able to be interpreted by one or more elements (e.g., a browser running in a user device, a mobile device application, etc.). The code snippets may be provided to the user or stored to one or more system-accessible storages.

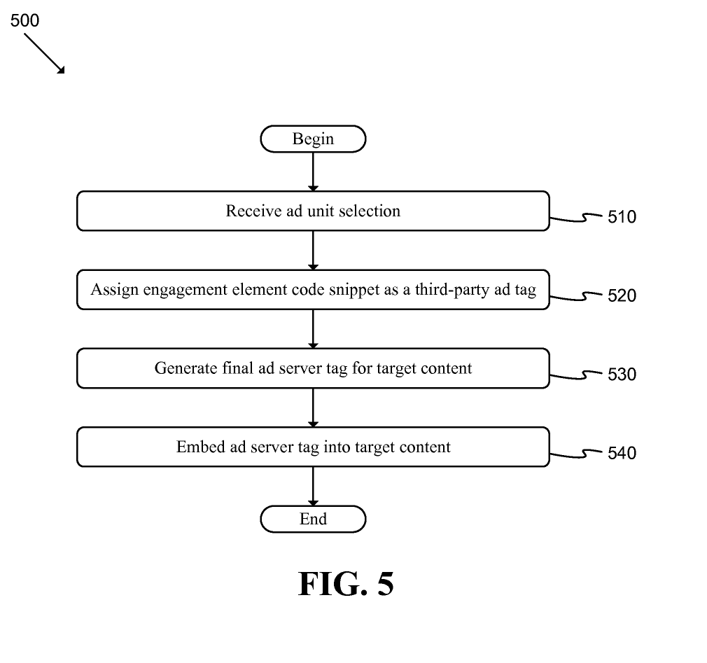

FIG. 5 illustrates a flow chart of an exemplary process 500 used by some embodiments to link engagement code to a set of advertisements. Such a process may begin, for instance, when a publisher-user accesses a system of some embodiments (e.g., by logging into an ad server).

As shown, the process may receive (at 510) an ad unit selection. Such a selection may be received in various appropriate ways (e.g., a user may make a selection from a list of available ad units, a user may specify an ad unit by dimension, etc.).

Next, the process may assign (at 520) an engagement element code snippet as a third-party ad tag for each selected ad unit. The process may then generate (at 530) a final ad server tag for the target content (e.g., the target web page). The final ad server tag may be generated automatically based at least partly on the ad unit selection received at 510, the engagement element code snippet assigned at 520, and/or other relevant factors.

Process 500 may then embed (at 540) the final ad server tag into the target content. Alternatively, the final ad server tag may be provided to a user for inclusion within the target content.

One of ordinary skill in the art will recognize that processes 300-500 are conceptual in nature and may be implemented in various different ways without departing from the scope of the disclosure. For instance, different embodiments may include additional operations and/or perform a sub-set of the described operations. As another example, some embodiments may perform the operations in different orders than shown. In addition, such a process may be broken into a set of sub-processes, or implemented as a sub-process of a macro process. Furthermore, such a process (and/or sub-process thereof) may be performed iteratively until some set of criteria is met.

B. User Engagement

Once engagement elements have been generated the elements (and/or associated content) may be presented to a user in various appropriate ways. Some example user interfaces (UIs) will be described in Section III below. The modes of engagement described below may be associated with different types of content and/or presentation of content. For instance, a first mode may be used to allow access to premium content while a second mode may allow a user to engage with content via a display ad space.

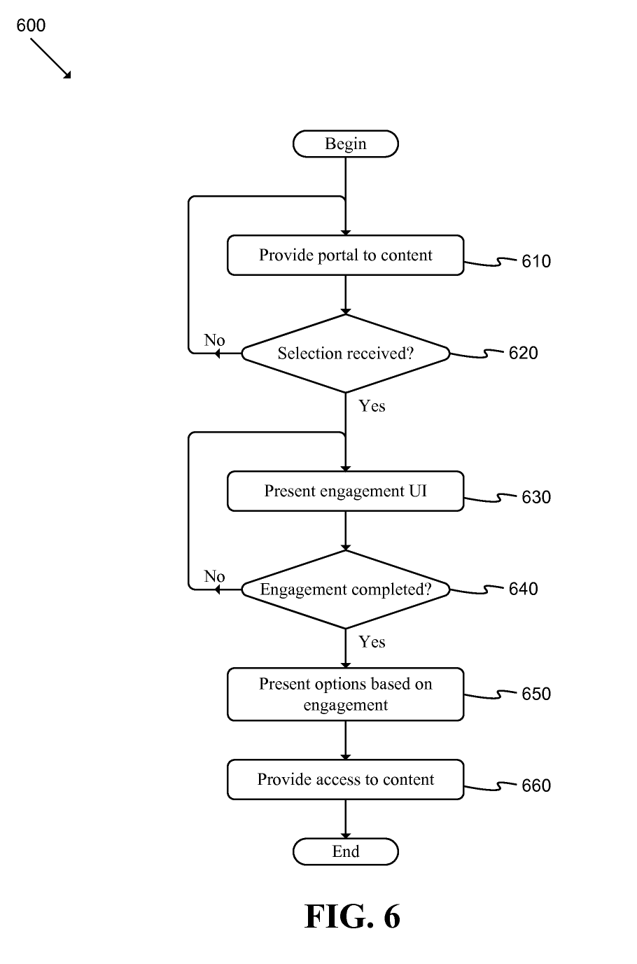

FIG. 6 illustrates a flow chart of an exemplary process 600 used by some embodiments to provide a first mode of user engagement. The first mode of user engagement may allow a publisher to require consumer-users to interact with an engagement element before providing access to premium or gated content. Such a process may begin, for instance, when a publisher-user publishes some content such that the content may be accessible to a set of consumer-users (e.g., by generating a publically accessible web page, by publishing the content to a forum, etc.).

As shown, the process may provide (at 610) a portal to the content (e.g., by presenting the content at a uniform resource locator or “URL”, by making the content available through a mobile device app, etc.). Next, the process may determine (at 620) whether a selection has been received. Such a determination may be made in various appropriate ways and may be based at least partly on actions taken by a particular consumer-user. For instance, such a selection may be made when a user selects a link associated with premium or gated content.

If the process determines (at 620) that no selection has been received, the process may iteratively perform operations 610-620 until the process determines (at 620) that a selection has been received.

After determining (at 620) that a selection has been received, the process may present (at 630) an engagement UI. Such an engagement UI may be presented in a separate browser tab, pop-up window, HTML overlay, etc. Some example UIs will be described below in Section III. The process may then determine (at 640) whether the engagement has been completed. Such a determination may be made in various appropriate ways and may be based at least partly on actions taken by a particular consumer-user in response to a presented engagement element. For instance, a user may have to complete a set of engagement tasks before access to the premium content is allowed.

If the process determines (at 630) that the engagement has not been completed, the process may iteratively perform operations 630-640 until the process determines (at 640) that the engagement has been completed.

If the process determines (at 640) that the engagement has been completed, the process may then present (at 650) options based at least partly on the engagement (e.g., based at least partly on the presented content, the actions taken by the consumer-user, etc.). Such options may include, for instance, links to external content (e.g., advertiser content), various selectable items such as re-deploying the engagement element, playing a video, continue to selected content, etc., and/or other appropriate elements such as coupons or other offers. Such options may be presented as selectable buttons within a web browser.

Depending on the selection from the options presented at 650, process 600 may perform various other appropriate actions (e.g., re-deploying an engagement element, launching a vendor website, etc.). In some embodiments, if no selection is made (and/or if a selection is made to access the premium content), the process may then provide (at 660) access to the premium content and then end. Such content may be provided via a web page or other appropriate ways.

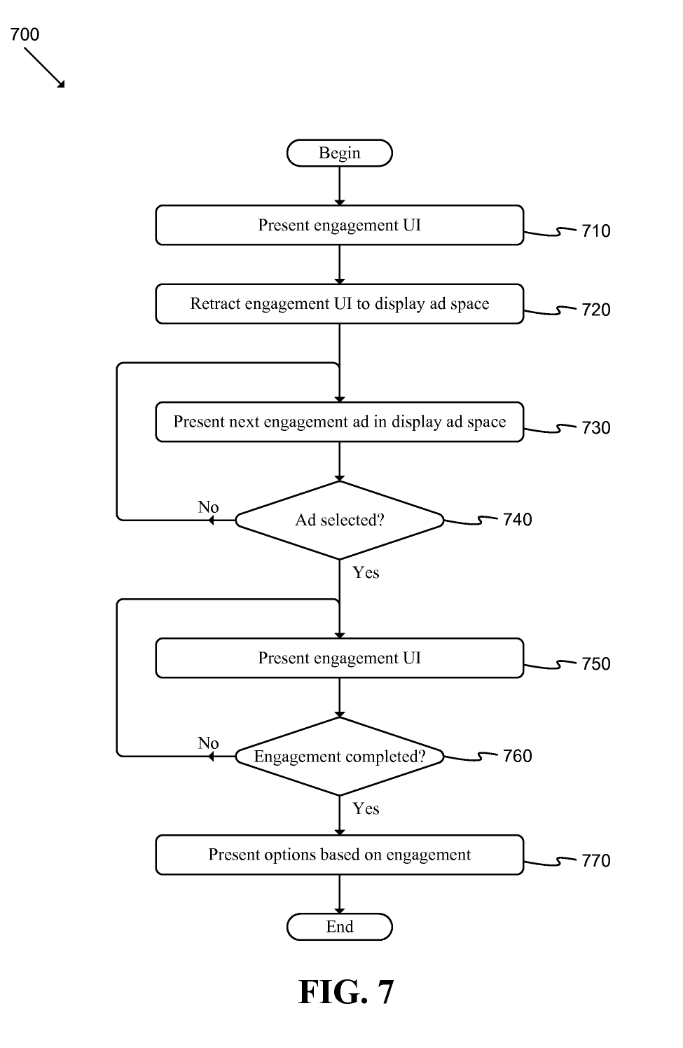

FIG. 7 illustrates a flow chart of an exemplary process 700 used by some embodiments to provide a second mode of user engagement. The second mode of user engagement may allow a publisher to automatically engage a user. Such a process may begin, for instance, when a consumer-user loads a web page having an appropriate engagement element.

As shown, the process may present (at 710) an engagement UI. Such an engagement UI may be presented as a pop-up window or web-page overlay when a user accesses a web page. If the engagement UI (or any sub-elements) is not selected by the user, the process may retract (at 720) the engagement UI to a display ad space (i.e., a space associated with at least one ad unit).

Process 700 may then present (at 730) the next engagement ad in the display ad space. For instance, some embodiments may associate a set of ads (e.g., three ads) with an engagement element and associated display ad space. Such ads may be provided by an ad server (e.g., based on a request for an ad of a certain size, based on a request for a specific ad, product, manufacturer, etc., and/or based on other relevant factors).

The process may then determine (at 740) whether an ad has been selected within an appropriate interval. Such a determination may be made in various appropriate ways (e.g., by determining that a user has clicked on the display ad location, clicked on a region within the display ad, etc.).

If the process determines (at 740) that no ad has been selected, the process may iteratively perform operations 730-740 until the process determines (at 740) that an ad has been selected. If the process determines (at 740) that an ad has been selected, the process may present (at 750) the engagement UI in a similar manner to that described above in reference to operation 710.

The process may then determine (at 760) whether the engagement has been completed. Such a determination may be made in various appropriate ways, as described above in reference to operation 640.

If the process determines (at 760) that the engagement has not been completed, the process may iteratively perform operations 750-760 until the process determines (at 760) that the engagement has been completed. If the process determines (at 760) that the engagement has been completed, the process may present (at 770) options based on the engagement in various appropriate ways, as described above in reference to operation 650. After presenting (at 770) the options, the process may end.

One of ordinary skill in the art will recognize that processes 600-700 are conceptual in nature and may be implemented in various different ways without departing from the scope of the disclosure. For instance, different embodiments may include additional operations and/or perform a sub-set of the described operations. As another example, some embodiments may perform the operations in different orders than shown. In addition, such a process may be broken into a set of sub-processes, or implemented as a sub-process of a macro process. Furthermore, such processes (and/or sub-processes thereof) may be performed iteratively until some set of criteria is met.

C. Communication Flow

When an engagement element is identified (e.g., when a web page is loaded), various system components may automatically interact to provide the engagement content to a consumer-user. Such interaction may involve calls and returns, and/or other forms of messaging. Such calls may be automatically made when, for instance, a web page is loaded.

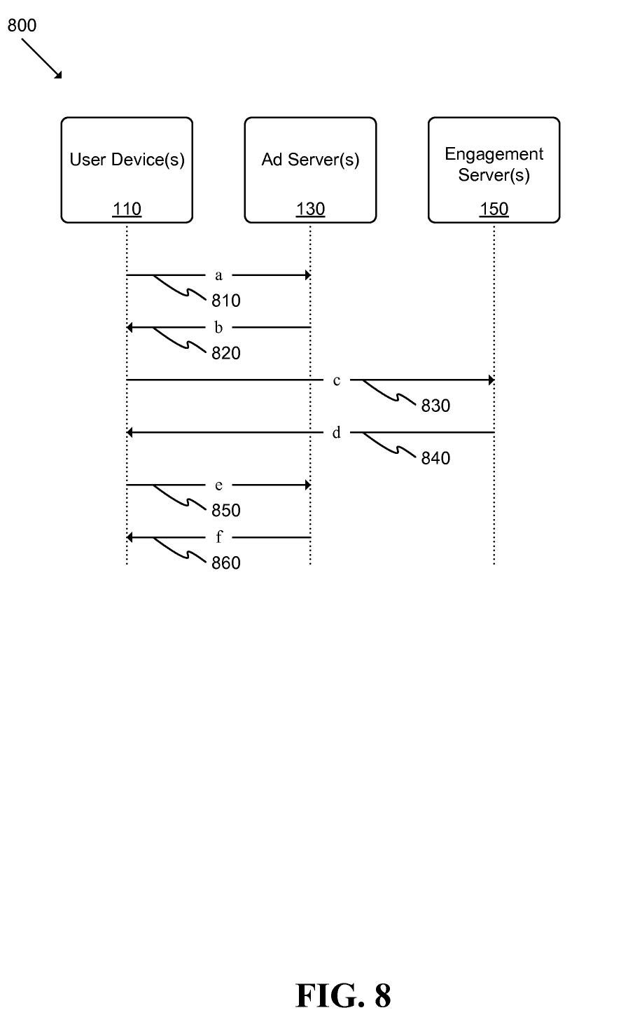

FIG. 8 illustrates a message flow diagram of an exemplary communication scheme 800 used by some embodiments to provide various modes of user engagement. In some embodiments, the messaging may be performed by elements such as the user device 110, ad server 130, and engagement server 140 described above in reference to FIG. 1.

Scheme 800 may be invoked, for instance, when a consumer-user loads a web page (e.g., a page provided by an element such as content server 120) that includes at least one engagement element. As described above, the engagement element may be activated in various appropriate ways (e.g., upon page loading, upon selection of content by a user, upon selection of an ad by a user, etc.).

Message ‘a’ 810 may include a call from the user device 110 to an ad server 130 using an ad tag associated with the web page. Such an ad tag may be generated using a process similar to process 500 described above. Next, message ‘b’ 820 may include a return of an ad that includes an engagement element ad tag. Such an ad tag may be generated using a process similar to process 300 described above.

Message ‘c’ 830 may include a call from the user device 110 to an engagement server 140 using an identifier associated with an engagement element. Such an identifier may be associated with the engagement element using a process similar to process 400 described above. Next, message ‘d’ 840 may include a return of an engagement ad that includes a set of ad server image tags. Such image tags may be provided by a service that provides the ads.

Message ‘e’ 850 may include a call from the user device 110 to the ad server 130 using the received image tag(s). Next, message ‘f’ 860 may include a return of ads and/or images associated with the image tags. In some embodiments, the ads may be specified by a publisher-user (e.g., specific ads or merchants may be selected and associated with the publisher content, a category of vendors may be specified, etc.) and/or may be determined at least partly by the ad server (e.g., a publisher-user may sign up for an ad service that automatically selects ads based on various factors such as type of publisher content, user preferences, etc.).

One of ordinary skill in the art will recognize that the communication scheme 800 described above may be implemented in various different ways without departing from the scope of the disclosure. For instance, different embodiments may include different sets of messages which may be sent and/or received by different sets of system components.

### III. Exemplary User Interfaces

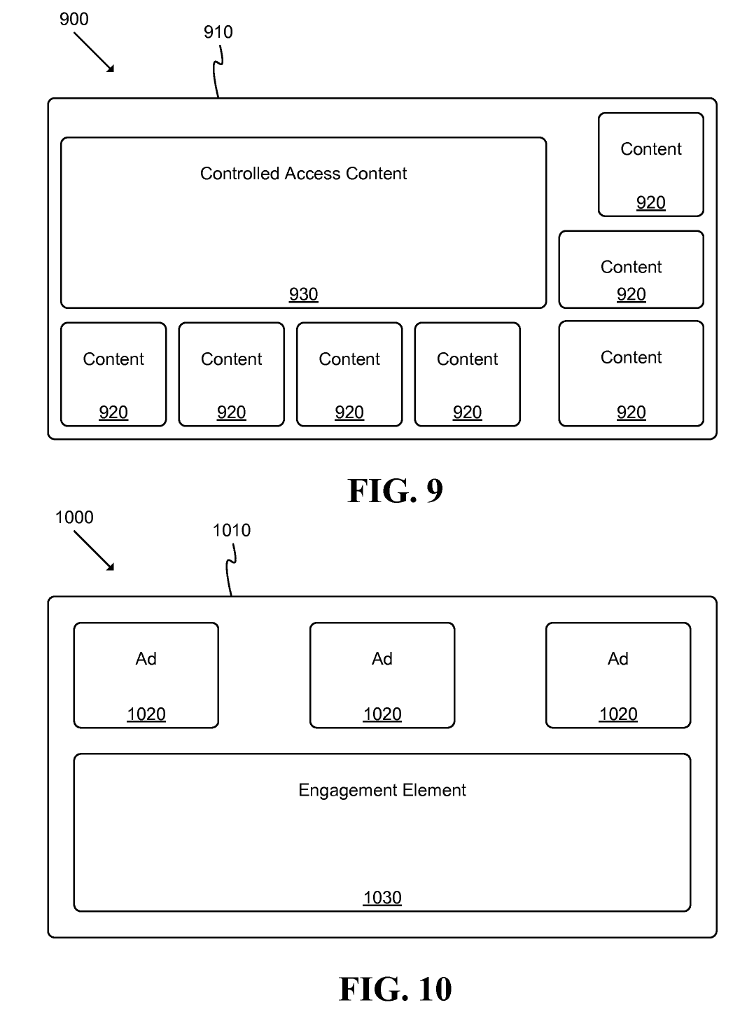

FIG. 9 illustrates an example user interface (UI) 900 associated with the first mode of user engagement described above in reference to FIG. 6. The UI may be presented within a web browser 910, which may include various controls, menus, etc. (not shown). The UI 900 may be associated with a web page that includes various content elements 920 and at least one controlled access content element 930. Each content element 920-930 may include various types of multimedia, for example, text elements, graphical elements, pictures, video, animation, audio, etc.

In this example, the UI 900 may represent a typical web site provided by an opinion magazine or other appropriate content provider. The provider may provide some content elements 920 without requiring any action by a user, but may control access to some content 930 such that a user has to fulfill some criteria to access the content. When a user selects the content 930, an engagement UI may be launched (e.g., in a separate window or tab, as an overlay to the web page 900, etc.).

FIG. 10 illustrates an example engagement UI 1000 provided by some embodiments. Such a UI may be presented using a web browser window 1010 and/or other appropriate elements (e.g., a user device app, a multimedia player, etc.). As shown, the engagement UI may include a set of ads 1020 and at least one engagement element 1030. The UI 1000 may include various other elements (e.g., banner ads, social media links, selection or termination buttons, etc.).

Each ad 1020 may be a typical display ad provided by an ad server. The ads may include various types of multimedia (e.g., images, text, graphic elements, video, audio, etc.). Such ads may typically be specified by size and may be scaled or otherwise modified for use within the UI 1000. The ads may be selected by a publisher-user when developing the engagement content, may be provided by an ad service, and/or may be selected in other appropriate ways.

The engagement element 1030 may include various types of engagement content.

Some examples of engagement content include games (e.g., shooting games, word games, puzzles, etc.). The engagement content may require user interaction that depends on the type of content. For example, a user may have to reach a point threshold in an invaders game by destroying enemy ships before a base is destroyed. As another example, a user may have to perform a word search for terms associated with one or more products, advertisers, and/or other relevant groups. As another example, an image (e.g., a picture of a celebrity spokesperson, product, etc.) may be divided into sections and rearranged such that a user has to move the sections to their proper positions to view the image. In some embodiments, the display areas associated with the engagement content and the ads 1020 may overlap such that the ads themselves are part of the engagement (e.g., a user may be able to repeatedly shoot an ad to select the ad).

The engagement content may determine that the user has satisfied some interaction criteria (e.g., by scoring above a threshold number of points, assembling a puzzle, etc.) some embodiments may present a satisfaction UI. Alternatively, a user may be able to opt-out of the engagement (e.g., by clicking a button after a minimum amount of time such as five seconds, by directly selecting one of the displayed ads 1020, etc.).

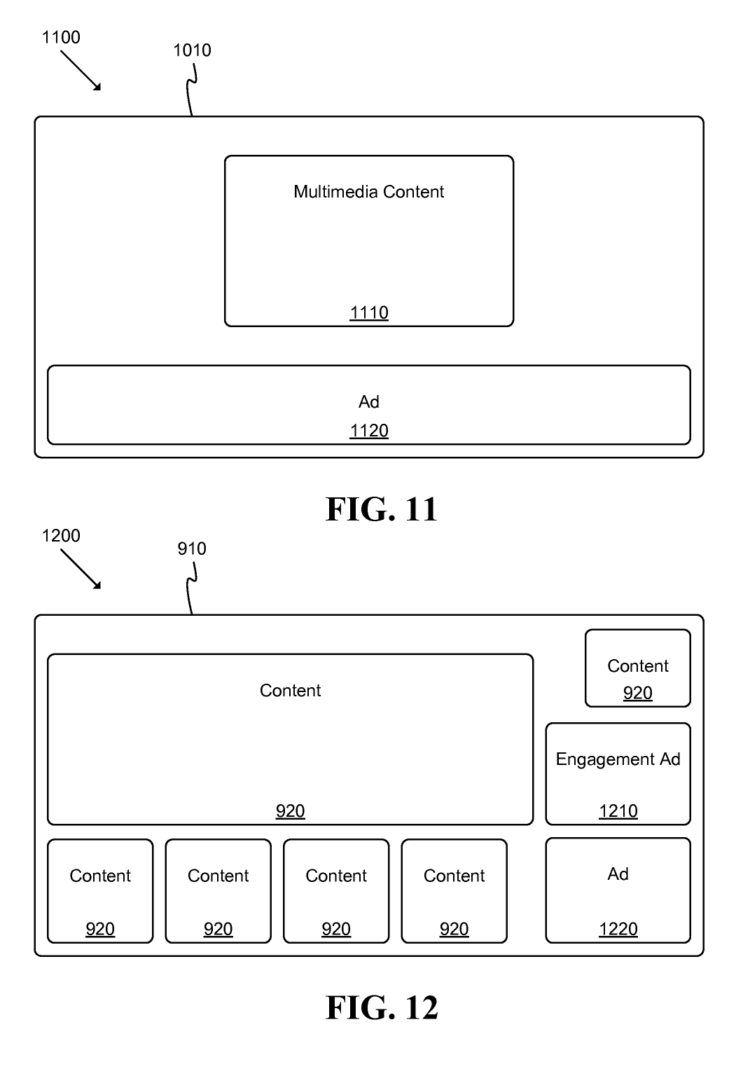

FIG. 11 illustrates an example satisfaction UI 1100. Such a UI may be presented using the web browser window 1010 and/or other appropriate ways. As shown, the UI 1100 may include multimedia content 1120 and an ad 1130. The multimedia content 1120 and/or ad 1130 may be selected based at least partly on the user interaction described above. The UI 1100 may include other appropriate elements such as selection buttons (e.g., “play again”, “watch the video”, a termination button, “continue to content”, etc.). In some embodiments, the multimedia content 1120 may begin playback when the UI 1100 is presented. Alternatively, a user may select playback using various selection elements provided by the UI 1100.

One of ordinary skill in the art will recognize that although the UIs 900-1100 have been described with reference to specific features, the UIs may be implemented in various different ways without departing from the scope of the disclosure. For instance, the UIs may include differently shaped, sized, or otherwise differently arranged elements. In addition, the UIs may include various different specific elements (e.g., buttons, lists, menus, content, etc.) and/or numbers of elements. Furthermore, the UIs may be modified or optimized depending at least partly on a type of user device or access software.

FIG. 12 illustrates an example UI 1200 associated with the second mode of user engagement described above in reference to FIG. 7. As above, the UI may be presented within a web browser 910, which may include various controls, menus, etc. (not shown). The UI 1200 may be associated with a web page that includes various content elements 920, at least one engagement ad 1210 (or “supercharged” ad), and may include other ads 1220. Each content element 920 may include various types of multimedia, for example, text elements, graphical elements, pictures, video, animation, audio, etc.

Each engagement ad 1210 may be associated with an engagement element. Each ad 1220 may be a typical display ad provided by an ad server. The ads may include various types of multimedia (e.g., images, text, graphic elements, video, audio, etc.). Such ads may typically be specified by size and may be scaled or otherwise modified for use within the UI 1200. The ads 1210-1220 may be selected by a publisher-user when developing the content, may be provided by an ad service, and/or may be selected in other appropriate ways.

In some embodiments, upon loading the web page 1200, an engagement UI similar to UI 1000 may be presented for a specified length of time (e.g., a few seconds). During this time, a user may be able to engage the UI in a similar manner to that described above in reference to FIGS. 10-11. Alternatively, if the user does not engage the UI, the UI 1000 may retract to engagement ad space 1210.

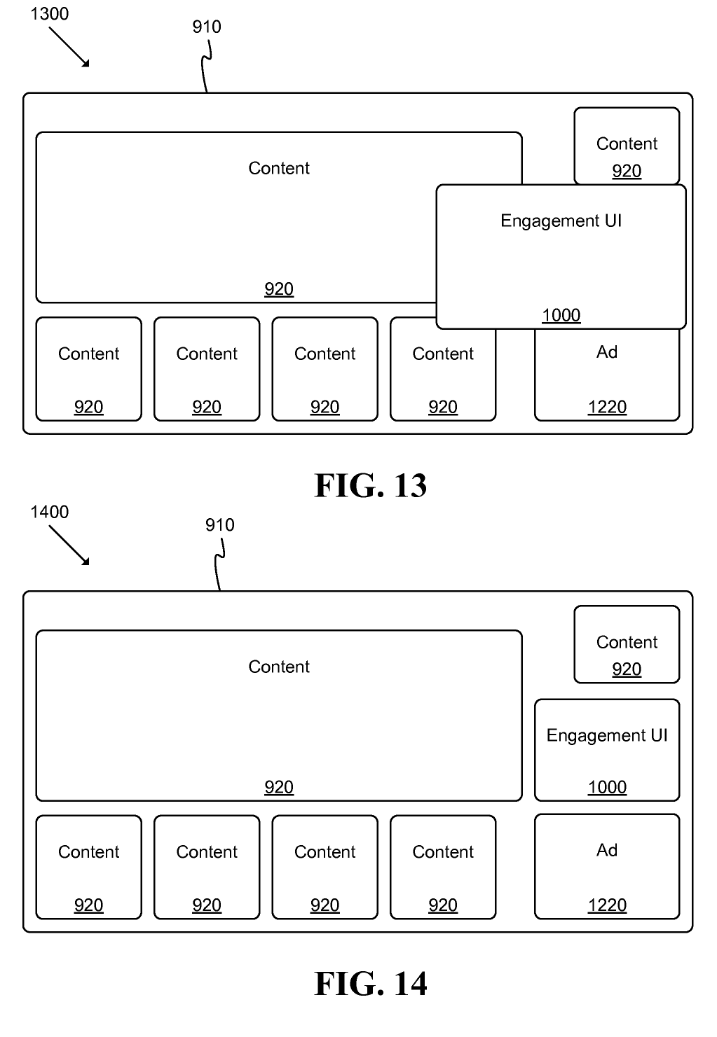

FIG. 13 illustrates an example UI 1300 that shows the engagement UI 1000 as the UI is being retracted to the engagement ad space 1210. FIG. 14 illustrates an example UI 1400 that shows the engagement UI 1000 after the UI has been refracted to the engagement ad space 1210.

After the engagement ad has been fully retracted, some embodiments may cycle through the set of ads associated with the engagement ad (e.g., by displaying each ad for ten seconds before moving to the next ad). If a user clicks on any of the associated ads, the engagement UI 1000 may be deployed as described above in reference to FIGS. 10-11.

One of ordinary skill in the art will recognize that although the UIs 1200-1400 have been described with reference to specific features, the UIs may be implemented in various different ways without departing from the scope of the disclosure. For instance, the UIs may include differently shaped, sized, or otherwise differently arranged elements. In addition, the UIs may include various different specific elements (e.g., buttons, lists, menus, content, etc.) and/or numbers of elements. Furthermore, the UIs may be modified or optimized depending at least partly on a type of user device or access software.

### IV. Gaming Environment

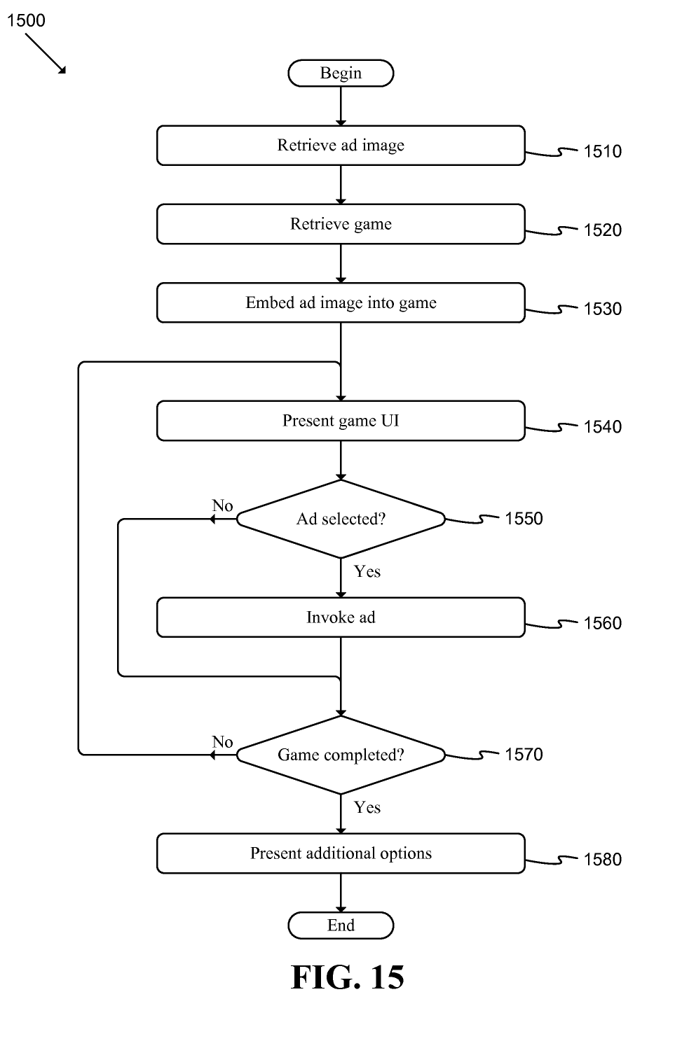

FIG. 15 illustrates a flow chart of an exemplary process 1500 used by some embodiments to integrate content into a gaming environment. As above, such a process may be used as part of a process for gating access to content. The process may begin when web-based or streaming content is accessed. Such a process may be executed by a client device such as a smartphone, a server device, other devices, and/or combinations of devices.

As shown, the process may retrieve (at 1510) an ad image. Such an image may be retrieved from an advertising provider or other appropriate network-accessible resource. Next, the process may retrieve (at 1520) at least one game associated with the gaming environment. In some cases, a set of games may be retrieved.

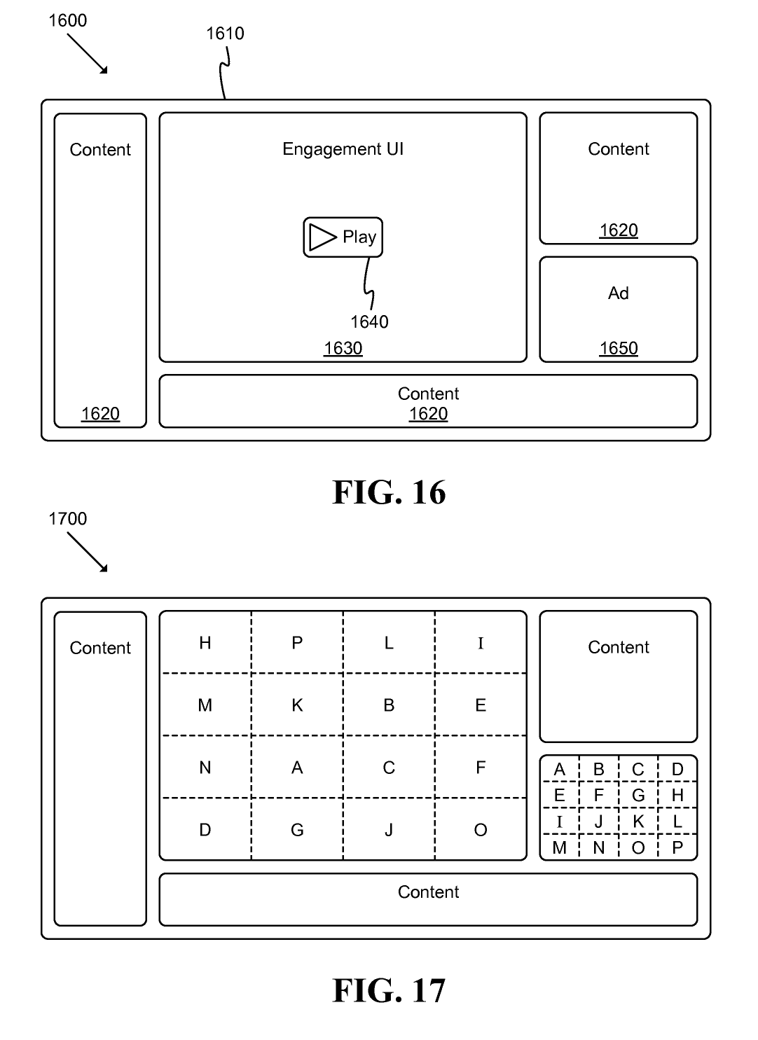

The process may then embed (at 1530) the ad image into the game. Next, the process may present (at 1540) a game UI. Various examples of such embedding and UIs will be described below in reference to FIGS. 16-23.

Process 1500 may then determine (at 1550) whether an ad has been selected within the gaming environment. If the process determines that the ad has been selected, the process may invoke (at 1560) the ad (e.g., by navigating to a resource associated with the advertisement).

After invoking (at 1560) the ad, or determining (at 1550) that no ad has been selected, the process may determine (at 1570) whether the game has been completed. If the process determines that the game has not been completed, the process may then repeat operations 1540-1570 until the process determines (at 1570) that the game has been completed. The process may then present (at 1580) additional options and then may end. Such additional options may include, for instance, access to gated content, coupons or rewards associated with the ad, etc.

One of ordinary skill in the art will recognize that process 1500 is conceptual in nature and may be implemented in various different ways without departing from the scope of the disclosure. For instance, different embodiments may include additional operations and/or perform a sub-set of the described operations. As another example, some embodiments may perform the operations in different orders than shown. In addition, such a process may be broken into a set of sub-processes, or implemented as a sub-process of a macro process. Furthermore, such a process (and/or sub-process thereof) may be performed iteratively until some set of criteria is met. In addition, such a process may be performed with content other than advertising content.

FIG. 16 illustrates an exemplary UI 1600 associated with the gaming environment. Such a UI may be presented using a web browser window 1610 and/or other appropriate elements (e.g., a user device app, a multimedia player, etc.). As shown, the gaming UI may include various content items 1620, an engagement item 1630, selectable elements 1640, and advertising content 1650.

FIG. 17 illustrates an example game UI 1700. As shown, the UI includes an engagement element having a set of re-arranged tiles that correspond to the ordered tiles generated from ad 1650. Some embodiments may automatically generate and rearrange the set of tiles based on an image associated with the ad.

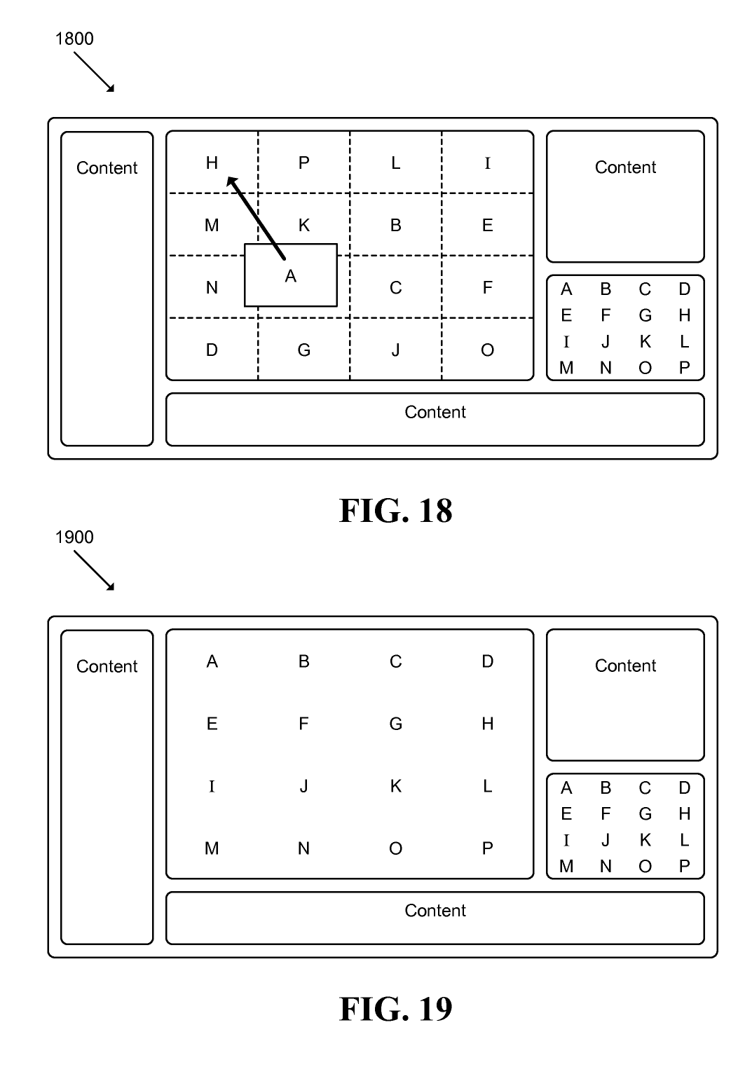

FIG. 18 illustrates an example game UI 1800 that continues the example of UI 1700. As shown, UI 1800 includes a tile being moved from one location to another by a user. The tiles may be moved in various appropriate ways (e.g., click and drag, selection and movement using keys, etc.). In a cross-screen application, one or more users may reposition one or more devices to achieve a similar result.

FIG. 19 illustrates an example game UI 1900 that continues the example of UIs 1700-1800. As shown, UI 1900 includes the correct tile arrangement, whereby the elements of engagement element 1630 match the elements of ad 1650.

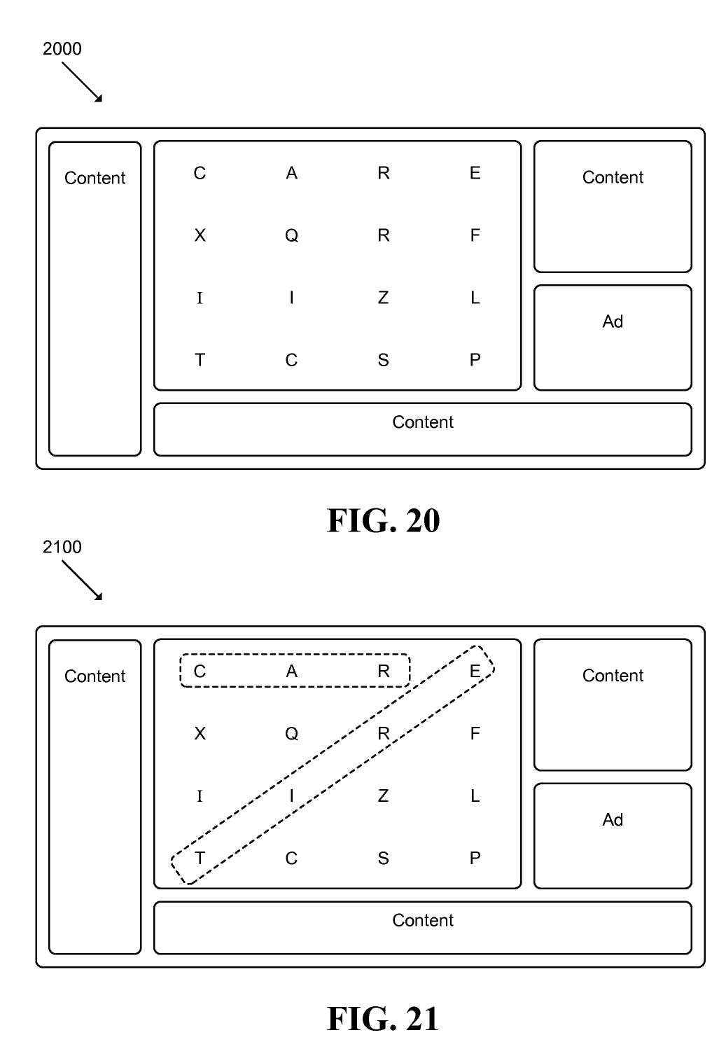

FIG. 20 illustrates an example game UI 2000. As shown, the UI includes an engagement element having a set of letters that may be selected to form words associated with the ad 1650. Some embodiments may automatically generate and arrange the letters based on keywords and/or other content associated with the ad.

FIG. 21 illustrates an example game UI 2100 that continues the example of UI 2000. As shown, UI 2100 includes various selected words (such words may be selected in various appropriate ways). In this example, the words may include keywords associated with an automotive ad.

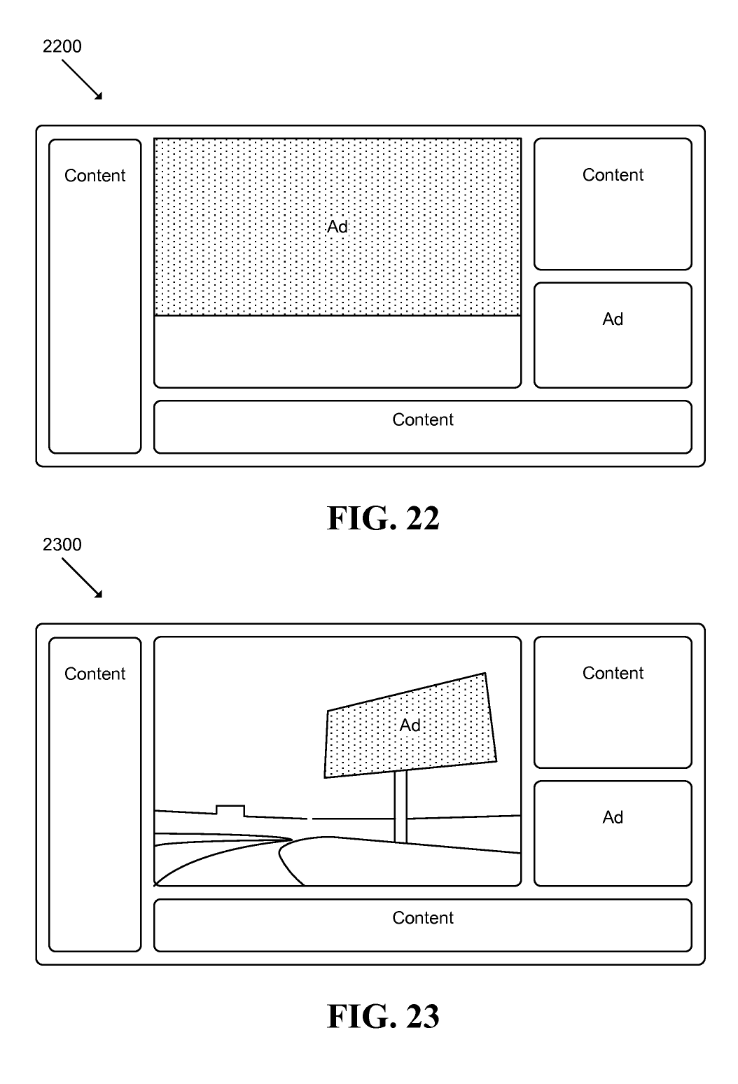

FIG. 22 illustrates an example game UI 2200. As shown, the UI includes an engagement element having background art associated with the ad 1650. Such background art may be integrated into various two-dimensional gaming environments where a character moves along the background from a start point to finish point. The image may be repeated within the background or background panel.

FIG. 23 illustrates an example game UI 2300. As shown, the UI includes an engagement element with ad content embedded into a three-dimensional environment. Such embedding may require various transformation operations (e.g., two-dimensional content may be rendered within a 3D environment such that the content is only visible from some angles, from certain positions, etc.).

In this example, a driving or other such three-dimensional environment shows the advertising content on a billboard visible to the user during gameplay. Such content may be embedded in various appropriate ways onto various appropriate elements within the gaming environment. For instance, as in this example, an image may be rendered onto a surface within the visible three-dimensional environment. Such a three-dimensional environment may be provided via a two-dimensional display using perspective and/or other attributes to present such an environment.

One of ordinary skill in the art will recognize that the UIs of FIGS. 16-23 may be implemented in various different ways without departing from the scope of the disclosure. For instance, in some embodiments the content may be embedded in various other types of games or environments (e.g., advertising within a sports stadium or other sporting game, associated with events, etc.).

### V. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

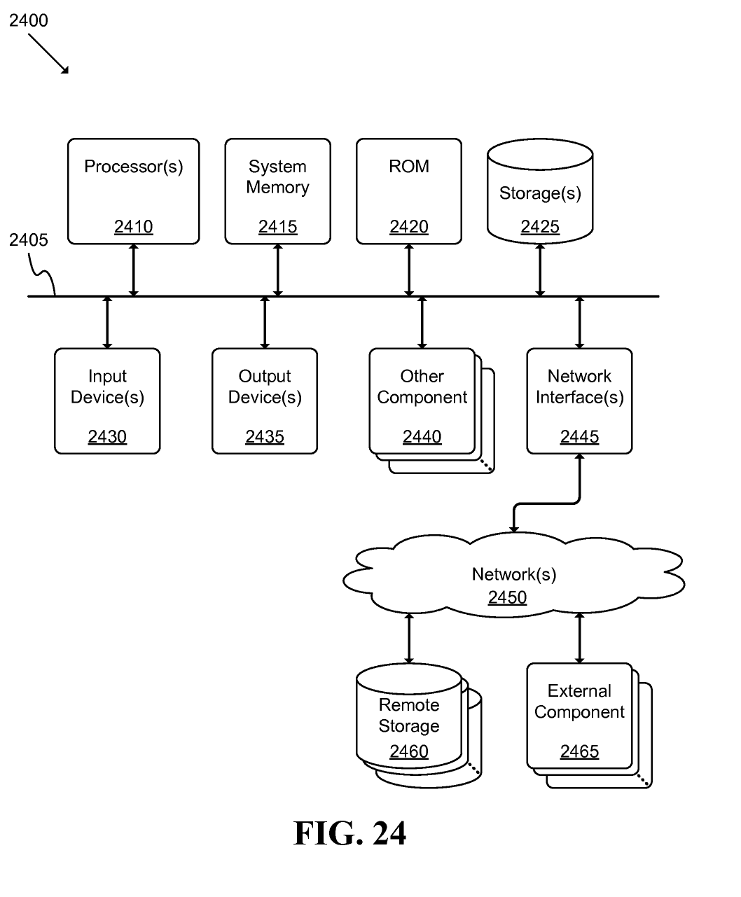

FIG. 24 illustrates a schematic block diagram of an exemplary computer system 2400 used to implement some embodiments. For example, the system described above in reference to FIGS. 1-2 may be at least partially implemented using computer system 2400. As another example, the processes described in reference to FIGS. 3-7, and 15 may be at least partially implemented using sets of instructions that are executed using computer system 2400.

Computer system 2400 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 2400 may include at least one communication bus 2405, one or more processors 2410, a system memory 2415, a read-only memory (ROM) 2420, permanent storage devices 2425, input devices 2430, output devices 2435, various other components 2440 (e.g., a graphics processing unit), and one or more network interfaces 2445.

Bus 2405 represents all communication pathways among the elements of computer system 2400. Such pathways may include wired, wireless, optical, and/or other appropriate communication pathways. For example, input devices 2430 and/or output devices 2435 may be coupled to the system 2400 using a wireless connection protocol or system.

The processor 2410 may, in order to execute the processes of some embodiments, retrieve instructions to execute and/or data to process from components such as system memory 2415, ROM 2420, and permanent storage device 2425. Such instructions and data may be passed over bus 2405.

System memory 2415 may be a volatile read-and-write memory, such as a random access memory (RAM). The system memory may store some of the instructions and data that the processor uses at runtime. The sets of instructions and/or data used to implement some embodiments may be stored in the system memory 2415, the permanent storage device 2425, and/or the read-only memory 2420. ROM 2420 may store static data and instructions that may be used by processor 2410 and/or other elements of the computer system.

Permanent storage device 2425 may be a read-and-write memory device. The permanent storage device may be a non-volatile memory unit that stores instructions and data even when computer system 2400 is off or unpowered. Computer system 2400 may use a removable storage device and/or a remote storage device as the permanent storage device.

Input devices 2430 may enable a user to communicate information to the computer system and/or manipulate various operations of the system. The input devices may include keyboards, cursor control devices, audio input devices and/or video input devices. Output devices 2435 may include printers, displays, and/or audio devices. Some or all of the input and/or output devices may be wirelessly or optically connected to the computer system.

Other components 2440 may perform various other functions. These functions may include performing specific functions (e.g., graphics processing, sound processing, etc.), providing storage, interfacing with external systems or components, etc.

Finally, as shown in FIG. 24, computer system 2400 may be coupled to one or more networks 2450 through one or more network interfaces 2445. For example, computer system 2400 may be coupled to a web server on the Internet such that a web browser executing on computer system 2400 may interact with the web server as a user interacts with an interface that operates in the web browser. Computer system 2400 may be able to access one or more remote storages 2460 and one or more external components 2465 through the network interface 2445 and network 2450. The network interface(s) 2445 may include one or more application programming interfaces (APIs) that may allow the computer system 2400 to access remote systems and/or storages and also may allow remote systems and/or storages to access computer system 2400 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 2400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope and scope of the disclosure as defined by the following claims.

I claim:

1. An automated method that provides access to gated content, the method performed by a device comprising a processor, the method comprising:
receiving content associated with an advertising item;
retrieving game content;
providing a gaming environment including the advertising item;
determining, via the gaming environment, whether a set of engagement criteria has been satisfied; and
providing a first set of options when determining that the set of engagement criteria has been satisfied, wherein the first set of options includes access to a gated content item.

2. The automated method of claim 1 further comprising providing a second set of options when determining that the set of engagement criteria has not been satisfied, wherein the second set of options excludes access to the gated content item.

3. The automated method of claim 1, wherein the content associated with the advertising item comprises an image.

4. The automated method of claim 3, wherein the gaming environment comprises a set of movable tiles, each tile associated with a section of the image.

5. The automated method of claim 4, wherein the set of engagement criteria comprises arrangement of the set of tiles in a same order as the sections of the image.

6. The automated method of claim 3, wherein the image is embedded into a background panel of the gaming environment.

7. The automated method of claim 3, wherein the image is rendered onto at least one surface of a three-dimensional gaming environment.

8. A user device that displays content, the user device comprising:
a processor for executing a set of instructions; and
a non-transitory medium that stores the set of instructions, wherein the set of instructions comprises:
receiving, from a server, content associated with an advertising item;
retrieving, from the server, game content;
providing, at the user device, a gaming environment including the advertising item;
determining, via the gaming environment, whether a set of engagement criteria has been satisfied; and
providing, at the user device, a first set of options when determining that the set of engagement criteria has been satisfied, wherein the first set of options includes access to a gated content item via the server.

9. The user device of claim 8, the set of instructions further comprising providing, at the user device, a second set of options when determining that the set of engagement criteria has not been satisfied, wherein the second set of options excludes access to the gated content item.

10. The user device of claim 8, wherein the content associated with the advertising item comprises an image.

11. The user device of claim 10, wherein the gaming environment comprises a set of movable tiles, each tile associated with a section of the image.

12. The user device of claim 11, wherein the set of engagement criteria comprises arrangement of the set of tiles in a same order as the sections of the image.

13. The user device of claim 10, wherein the image is embedded into a background panel of the gaming environment.

14. The user device of claim 10, wherein the image is rendered onto at least one surface of a three-dimensional gaming environment.

15. A server that provides content to a user, the server comprising:
a processor for executing a set of instructions; and
a non-transitory medium that stores the set of instructions, wherein the set of instructions comprises:
sending, to a user device, content associated with an advertising item;
retrieving game content;
providing, to the user device, a gaming environment including the advertising item;
determining, via the gaming environment, whether a set of engagement criteria has been satisfied; and
sending, to the user device, a first set of options when determining that the set of engagement criteria has been satisfied, wherein the first set of options includes access to a gated content item.

16. The server of claim 15, the set of instructions further comprising sending, to the user device, a second set of options when determining that the set of engagement criteria has not been satisfied, wherein the second set of options excludes access to the gated content item.

17. The server of claim 15, wherein the content associated with the advertising item comprises an image.

18. The server of claim 17, wherein the gaming environment comprises a set of movable tiles, each tile associated with a section of the image.

19. The server of claim 17, wherein the image is embedded into a background panel of the gaming environment.

20. The server of claim 17, wherein the image is rendered onto at least one surface of a three-dimensional gaming environment.
